(19) United States
(12) Patent Application Publication
(10) Pub. No.: US 2024/0312905 A1
(43) Pub. Date: Sep. 19, 2024

(54) Techniques For Providing Supply Current To Dies In A System Using An Inductor

(71) Applicant: Altera Corporation, San Jose, CA (US)

(72) Inventors: Md Altaf Hossain, Portland, OR (US); Atul Maheshwari, Portland, OR (US); Mahesh Kumashikar, Bangalore (IN); Ankireddy Nalamalpu, Portland, OR (US); Krishna Bharath Kolluru, Portland, OR (US)

(73) Assignee: Altera Corporation, San Jose, CA (US)

(21) Appl. No.: 18/677,712

(22) Filed: May 29, 2024

(51) Int. Cl. H01L 23/522; H01L 23/498; H01L 23/528; H01L 25/065

(52) U.S. Cl. CPC H01L 23/5227; H01L 23/49816; H01L 23/5286; H01L 25/0652; H01L 2225/06513

(57) ABSTRACT

An integrated circuit package includes first and second integrated circuit dies stacked vertically and coupled together, a connection device coupled to the first integrated circuit die, and a power delivery device coupled to the connection device. The power delivery device includes an inductor. The inductor generates supply current. The inductor is coupled to provide the supply current from the inductor to the first integrated circuit die through the connection device.

### TECHNICAL FIELD

The present disclosure relates to electronic circuit systems, and more particularly, to techniques for providing supply current to integrated circuit dies in a system using an inductor.

### BACKGROUND

Integrated circuits (ICs) are often housed in integrated circuit (IC) packages. An IC package that contains multiple ICs is often referred to as a multi-chip module (MCM). A MCM can include conductors that couple the ICs in the MCM to each other and to external devices outside the MCM.

### BRIEF DESCRIPTION OF DRAWINGS

FIG. 1 is a diagram that depicts a cross sectional view of an example of an integrated circuit (IC) package that contains multiple integrated circuit (IC) dies stacked in two layers and a power delivery device that is used to route power to the IC dies in the top layer.

FIG. 2 is a diagram that depicts a top down view of the IC package of FIG. 1.

FIG. 3 is a diagram that depicts a cross sectional view of an example of an integrated circuit (IC) package that contains multiple IC dies stacked in multiple layers and inductors and/or voltage regulator circuits used for power delivery.

FIG. 4 is a diagram that depicts a cross sectional view of another example of an integrated circuit (IC) package that contains multiple IC dies stacked in multiple layers and inductors and/or voltage regulator circuits used for power delivery.

FIG. 5 is a diagram that illustrates an example of a configurable logic IC that can be in an IC package as disclosed herein.

FIG. 6A illustrates a block diagram of a system that can be used to implement a circuit design to be programmed onto a programmable logic device using design software.

FIG. 6B is a diagram that depicts an example of a programmable logic device that includes three fabric die and two base die that are connected to one another via microbumps.

FIG. 7 is a block diagram illustrating a computing system configured to implement one or more aspects of the embodiments described herein.

### DETAILED DESCRIPTION

In some integrated circuit (IC) packages, multiple configurable integrated circuit (IC) dies are interconnected through an interposer within a single IC package to provide higher density devices. The configurable IC dies in an IC package form a multi-chip module (MCM). In an MCM with IC dies stacked in two or more layers, power delivery to the IC dies in the top layer of the MCM may result in undesirably large supply voltage drop or reduced supply current. Therefore, it would be desirable to optimize power delivery to the IC dies in the top layer of an MCM using techniques that reduce voltage drop and provide adequate supply current.

According to some examples disclosed herein, an integrated circuit (IC) package is provided that contains multiple integrated circuit (IC) dies stacked in two or more layers from a cross sectional perspective. The IC package includes a power delivery device containing one or more inductors. The power delivery device can be, for example, positioned above the top layer of the IC dies. One or more power supply voltages and/or ground voltages are routed through the one or more inductors in the power delivery device to the IC dies in the top layer. The inductor(s) maintain the supply current at a more constant value for each of the one or more power supply voltages and/or ground voltages that are provided through the inductor(s).

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the terms “connected” and “connection” mean a direct electrical connection between the circuits that are connected, without any intermediary devices. The terms “coupled” and “coupling” mean either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) logic integrated circuits, such as field programmable gate arrays (FPGAs) and programmable logic devices. As discussed herein, an integrated circuit (IC) can include hard logic and/or soft logic. The circuits in an integrated circuit device (e.g., in a configurable logic IC) that are configurable by an end user are referred to as “soft logic.” “Hard logic” generally refers to circuits in an integrated circuit device that have substantially fewer configurable features than soft logic or no configurable features.

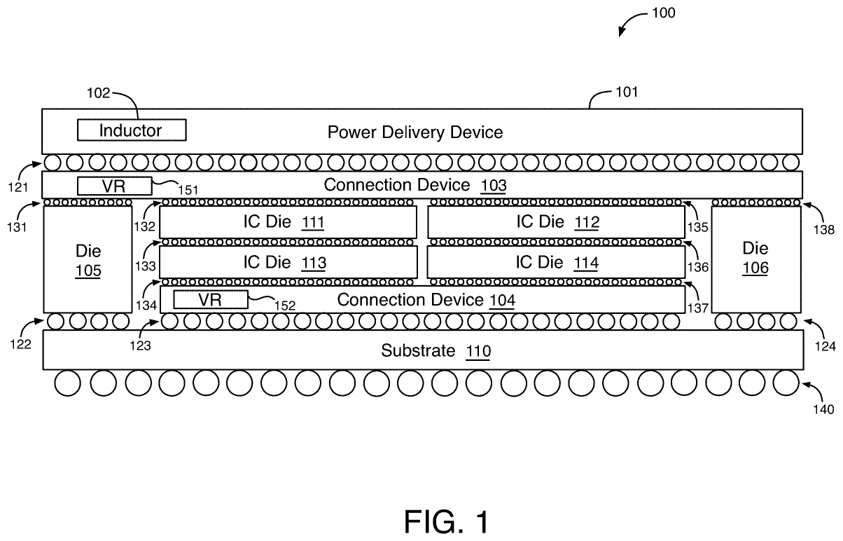

Figure (FIG. 1 is a diagram that depicts a cross sectional view of an example of an integrated circuit (IC) package 100 that contains multiple integrated circuit (IC) dies stacked in two layers and a power delivery device 101 that is used to route power to the IC dies in the top layer. The IC package 100 includes the power delivery device 101, connection devices 103-104, a substrate 110, integrated circuit dies 111-114, silicon dies 105-106, conductive connections 121-124 and 131-138, and conductive balls 140. The power delivery device 101 includes at least one inductor 102.

The substrate 110 is a package substrate that can be coupled to a circuit board (not shown) through conductive balls 140 (e.g., solder balls). The substrate 110 is coupled to the die 105 through conductive connections 122. The substrate 110 is coupled to the connection device 104 through conductive connections 123. The substrate 110 is coupled to the die 106 through conductive connections 124. The conductive connections 121-124 and 131-138 can be, for example, conductive microbumps of varying sizes.

The connection device 104 is coupled to the IC die 113 through conductive connections 134. The connection device 104 is coupled to the IC die 114 through conductive connections 137. The IC dies 111 and 113 are stacked vertically and coupled together through the conductive connections 133. The IC dies 112 and 114 are stacked vertically and coupled together through the conductive connections 136. The IC die 111 is coupled to the connection device 103 through conductive connections 132. The IC die 112 is coupled to the connection device 103 through conductive connections 135. The die 105 is coupled to the connection device 103 through conductive connections 131. The die 106 is coupled to the connection device 103 through conductive connections 138. The connection device 103 is coupled to the power delivery device 101 through conductive connections 121. The power delivery device 101 is located above the connection device 103, which is located above the IC dies 111-114.

The connection device 104 can be, as examples, an active interposer, a passive interposer, or an integrated circuit die. According to various examples, if connection device 104 is an active interposer or an integrated circuit die, connection device 104 can include one or more fully integrated voltage regulator circuits, such as voltage regulator (VR) circuit 152 shown in FIG. 1. The connection device 103 can be, as examples, an active interposer, a passive interposer, or an integrated circuit die. According to various examples, if connection device 103 is an active interposer or an integrated circuit die, connection device 103 can include one or more fully integrated voltage regulator circuits, such as voltage regulator (VR) circuit 151 shown in FIG. 1.

The power delivery device 101 can be, as examples, an integrated circuit die (e.g., a silicon die), a substrate, or an active interposer. The inductor 102 can, for example, be a discrete inductor that is embedded within layers of the power delivery device 101. As another example, the inductor 102 can be formed using turns of conductors in one or more layers of the power delivery device 101 that are coupled together to form a coil.

According to some examples, the inductor 102 is part of a voltage regulator circuit that is within the power delivery device 101, the connection device 103, or the connection device 104. In this example, the inductor 102 is used to stabilize the supply current for a power supply voltage that is generated by the voltage regulator circuit. The voltage regulator circuit can generate the power supply voltage using an input voltage (e.g., an unregulated supply voltage) that is provided from an external source, for example, through the substrate 110, the dies 105 or 106, and the connection device 103.

According to various examples, a power supply voltage or a ground voltage is delivered through the inductor 102 in the power delivery device 101 to the IC dies 111-112 in the top layer of the IC dies 111-114. As one example, a power supply voltage and/or ground voltage can be delivered from a circuit board through conductive balls 140, through conductors in substrate 110, through conductive connections 122 and/or 124, through conductors (e.g., conductive vias) in die 105 and/or 106, through conductive connections 131 and/or 138, through conductors in connection device 103, through conductive connections 121, and through conductors in power delivery device 101 to inductor 102.

The inductor 102 maintains the supply current for the power supply voltage or ground voltage at a more constant value. The inductor 102 can also be part of a voltage regulator circuit that reduces voltage drop in a power supply voltage. The supply current for the power supply voltage or ground voltage is delivered from the inductor 102 to IC die 111 through conductors in power delivery device 101, through conductive connections 121, through conductors in connection device 103, and through conductive connections 132. The supply current for the power supply voltage or ground voltage can also or alternatively be delivered from the inductor 102 to IC die 112 through conductors in power delivery device 101, through conductive connections 121, through conductors in connection device 103, and through conductive connections 135.

The power supply voltage and/or ground voltage from inductor 102 is used to power circuits in IC dies 111-112. The inductor 102 can provide robust and efficient power supply delivery to the front sides of the IC dies 111-112 so that voltage drop is not significant enough to impact performance of the IC dies 111-112. This configuration can cause an area overhead (e.g., about 10-12%) to support robust power delivery in three-dimensional IC die stacking.

The power delivery device 101 can also include additional inductors that are used to stabilize the supply currents for additional power supply voltages and/or ground voltages. The supply currents for these additional power supply voltages and/or ground voltages can be delivered from these inductors through conductors in power delivery device 101, through conductive connections 121, through conductors in connection device 103, and through conductive connections 132 and 135 to IC dies 111 and 112, respectively. These additional power supply voltages and/or ground voltages are also used to power circuits in IC dies 111-112.

According to other examples, one or more of the power delivery device 101, the connection device 103, and/or the connection device 104 can include a voltage regulator circuit that generates a power supply voltage for powering circuits in one or more of the IC dies 111-114. Inductor 102 can be part of one of these voltage regulator circuits. As an example, voltage regulator (VR) circuit 152 in connection device 104 can receive one or more input voltages for generating one or more power supply voltages from a device outside IC package 100. The one or more input voltages can be delivered to the voltage regulator circuit 152 through the conductive balls 140, substrate 110, and conductive connections 123. One or more of the power supply voltages generated by voltage regulator circuit 152 in connection device 104 can be delivered to one or both of IC dies 111-112 through IC dies 113-114 and conductive connections 133-134 and 136-137, respectively.

Also, one or more of the power supply voltages that are generated by voltage regulator circuit 152 in connection device 104 can be delivered to inductor 102 and/or other inductors in power delivery device 101 through conductive connections 123, through conductors in substrate 110, through conductive connections 122 and/or 124, through conductors in dies 105 and/or 106, through conductive connections 131 and/or 138, through conductors in connection device 103, and through conductive connections 121. Supply currents for these power supply voltages are provided through the inductors in power delivery device 101. The supply currents for these power supply voltages are then delivered from the inductors in power delivery device 101 through conductive connections 121, conductors in connection device 103, and conductive connections 132 and 135 to IC dies 111-112, respectively.

As another example, a voltage regulator (VR) circuit 151 in the connection device 103 can receive one or more input voltages for generating one or more power supply voltages from a device outside IC package 100. The one or more input voltages can be delivered to voltage regulator circuit 151 in connection device 103 through the conductive balls 140, substrate 110, conductive connections 122 and/or 124, dies 105 and/or 106, and conductive connections 131 and/or 138. The voltage regulator circuit 151 can generate one or more power supply voltages that are delivered to the inductor 102 and possibly other inductors in power delivery device 101. Supply currents for these power supply voltages are provided through the inductors in power delivery device 101 and subsequently through conductive connections 121, conductors in connection device 103, and conductive connections 132 and 135 to IC dies 111-112, respectively. The connection devices 103-104, the dies 105-106, and the conductive connections of FIG. 1 can also be used for transmitting input and output signals between the IC dies 111-114 and to and from one or more devices that are outside the IC package 100.

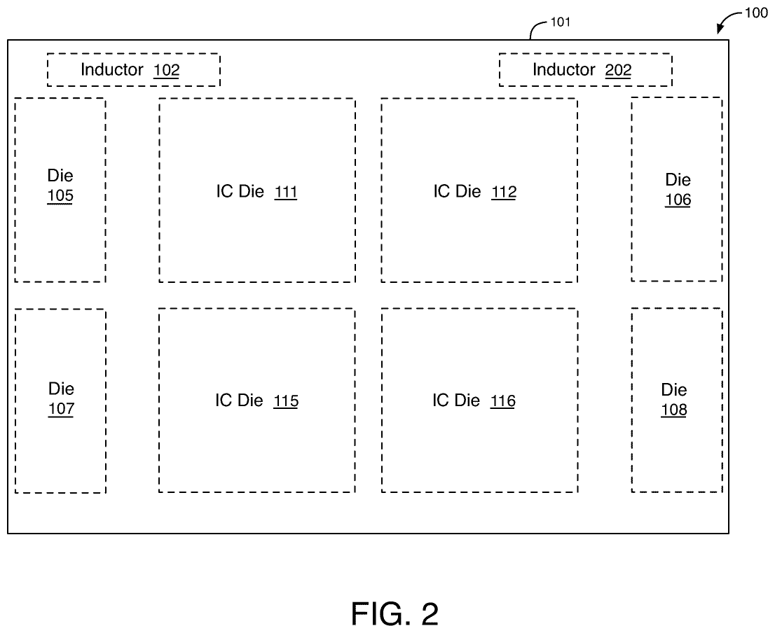

FIG. 2 is a diagram that depicts a top down view of the IC package 100 of FIG. 1. As shown in FIG. 2, the IC package 100 includes power delivery device 101 with the inductor 102, IC dies 111-112, and silicon dies 105-106, which are also shown in FIG. 1. In the example of FIG. 2, the IC package 100 also includes an additional inductor 202 in the power delivery device 101, two additional silicon dies 107-108, and four additional IC dies, including IC dies 115-116. Two of these 4 additional IC dies are stacked below IC dies 115-116 and are not shown in FIG. 2. Thus, in the example of FIG. 2, the IC package 100 includes 8 IC dies, including IC dies 111-116. IC dies 111-112 and 115-116 are in the top layer of the IC dies in IC package 100. Each of the IC dies 111-112 and 115-116 is vertically stacked on top of another IC die.

Also, in the example of FIG. 2, the IC package 100 includes 4 silicon dies 105-108 that are used for power supply voltage and ground voltage delivery and for the delivery of input and output signals to and from the IC dies. The inductors 102 and 202 are used to provide supply currents for power supply voltages and/or ground voltages to the IC dies 111-112 and 115-116 that are located in the top layer of IC dies in the IC package 100. It should be understood that the principles and techniques disclosed herein can be applied in IC packages having any number of IC dies, silicon dies, inductors, interposers, and power delivery devices.

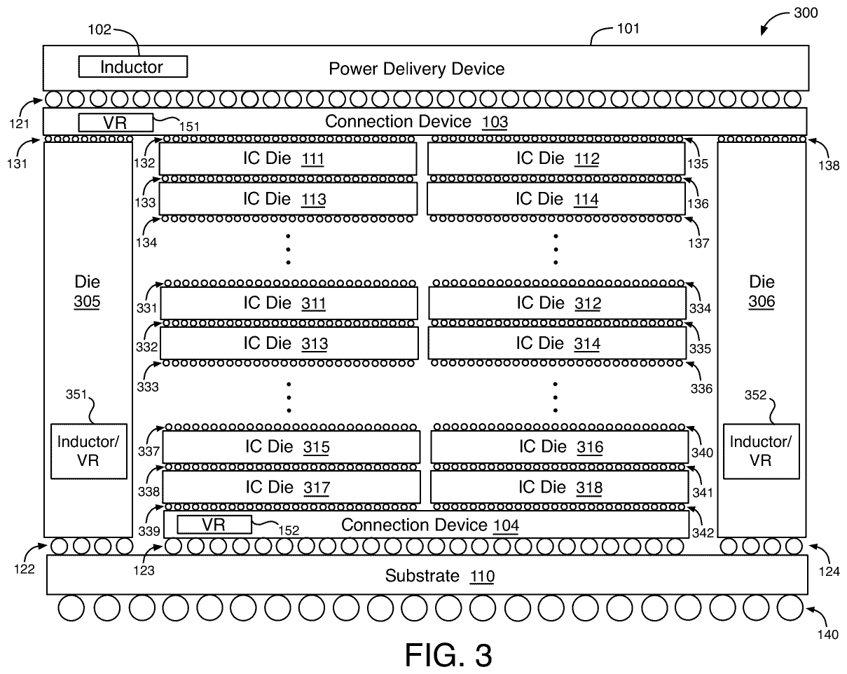

FIG. 3 is a diagram that depicts a cross sectional view of an example of an integrated circuit (IC) package 300 that contains multiple integrated circuit (IC) dies stacked in multiple layers. The IC package 300 includes the power delivery device 101, connection devices 103-104, substrate 110, 2 silicon dies 305-306, conductive balls 140, and conductive connections 121-124, 131-138, and 331-342.

In the example of FIG. 3, IC package 300 includes two vertical stacks of integrated circuit (IC) dies, including IC dies 111-114 and 311-318. Each of the vertical stacks of IC dies includes 6 or more IC dies in the example of FIG. 3. Although 6 IC dies are shown in each stack in FIG. 3, IC package 300 can have any number of IC dies in each stack. The first vertical stack includes IC dies 111, 113, 311, 313, 315, and 317, and the second vertical stack includes IC dies 112, 114, 312, 314, 316, and 318.

The IC dies in each stack are coupled together through conductive connections. For example, IC dies 311 and 313 are coupled together through conductive connections 332. IC dies 312 and 314 are coupled together through conductive connections 335. IC dies 315 and 317 are coupled together through conductive connections 338. IC dies 316 and 318 are coupled together through conductive connections 341.

IC dies 311-312 are coupled to two other IC dies in the first and second stacks through conductive connections 331 and 334, respectively. IC dies 313-314 are coupled to two other IC dies in the first and second stacks through conductive connections 333 and 336, respectively. IC dies 315-316 are coupled to two other IC dies in the first and second stacks through conductive connections 337 and 340, respectively. IC dies 317-318 are coupled to connection device 104 through conductive connections 339 and 342, respectively.

Die 305 is coupled between connection device 103 and the substrate 110 through conductive connections 131 and 122, and die 306 is coupled between connection device 103 and substrate 110 through conductive connections 138 and 124. Dies 305 and 306 include inductors and/or voltage regulator (VR) circuits 351 and 352, respectively.

The inductor and/or voltage regulator circuit 351 in die 305 and the inductor and/or voltage regulator circuit 352 in die 306 are used to stabilize the supply current for one or more power supply voltages or ground voltages. The inductors and/or voltage regulator circuits 351 and 352 can receive one or more input voltages, ground voltages, or power supply voltages through balls 140, substrate 110, conductive connections 122 and 124, and conductors in dies 305 and 306, respectively.

According to various examples, one or more power supply voltages and/or ground voltages are delivered through the inductors and/or voltage regulator circuits 351 and 352 to the IC dies in the top and/or middle layers of the stacks, such as IC dies 111-114 and/or IC dies 311-314. As an example, a power supply voltage and/or ground voltage can be delivered from a circuit board through conductive balls 140, through conductors in substrate 110, through conductive connections 122 and/or 124, and through conductors (e.g., conductive vias) in dies 305 and/or 306 to the inductors and/or voltage regulator circuits 351 and 352. The inductors and/or voltage regulator circuits 351 and 352 maintain the supply currents for the power supply voltage and/or ground voltage at more constant values.

The supply currents for the power supply voltage and/or ground voltage are delivered from the inductors and/or voltage regulator circuits 351 and 352 to one or more of IC dies 111-114, 311-314, and other IC dies in the stacks through conductors (e.g., conductive vias) in dies 305 and/or 306, through conductive connections 131 and/or 138, through conductors in connection device 103, and through conductive connections 132-137 and 331-336. The power supply voltage and/or ground voltage from the inductors and/or voltage regulator circuits 351 and 352 are used to power circuits in IC dies 111-114, 311-314, and other IC dies in the stacks.

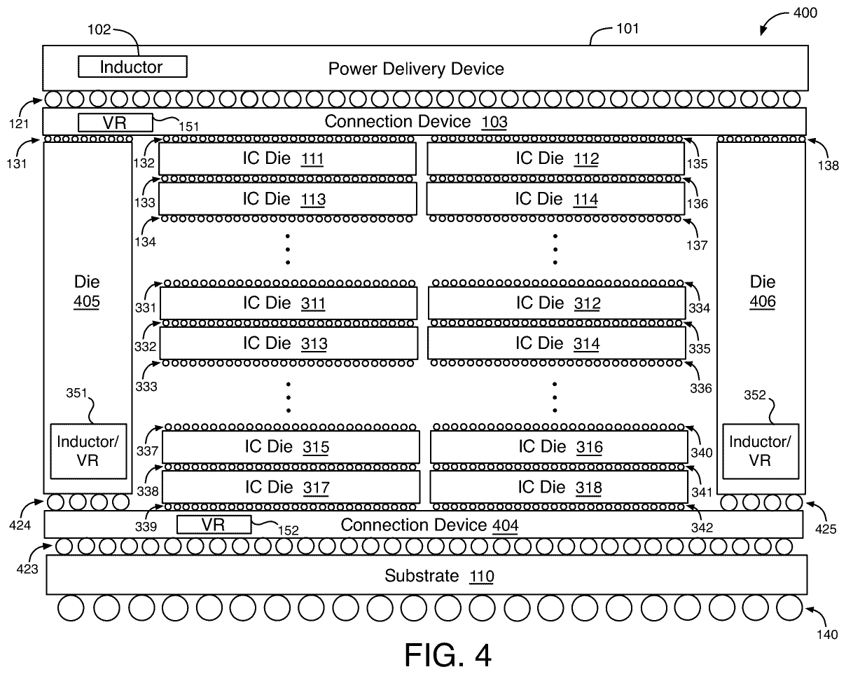

FIG. 4 is a diagram that depicts a cross sectional view of another example of an integrated circuit (IC) package 400 that contains multiple IC dies stacked in multiple layers. The IC package 400 includes power delivery device 101, connection devices 103 and 404, substrate 110, silicon dies 405-406, conductive balls 140, and conductive connections 121, 131-138, 331-342, and 423-425. In the example of FIG. 4, IC package 400 includes two vertical stacks of integrated circuit (IC) dies, including IC dies 111-114 and 311-318. Each of the vertical stacks of IC dies includes 6 or more IC dies. Although 6 IC dies are shown in each stack in FIG. 4, IC package 400 can have any number of IC dies.

In the example of FIG. 4, the connection device 404 is coupled to the substrate 110 through conductive connections 423. The connection device 404 is coupled to the dies 405 and 406 through conductive connections 424 and 425, respectively. The connection device 404 is coupled to the IC dies 317 and 318 through conductive connections 339 and 342, respectively.

Die 405 is coupled between connection devices 103 and 404 through conductive connections 131 and 424, respectively. Die 406 is coupled between connection devices 103 and 404 through conductive connections 138 and 425, respectively. Dies 405 and 406 include the inductors and/or voltage regulator (VR) circuits 351 and 352, respectively.

The inductor and/or voltage regulator circuit 351 in die 405 and the inductor and/or voltage regulator circuit 352 in die 406 are used to stabilize the supply currents for one or more power supply voltages and/or ground voltages. The inductors and/or voltage regulator circuits 351 and 352 can receive one or more input voltages, ground voltages, or power supply voltages through balls 140, substrate 110, conductive connections 423, conductors in connection device 404, conductive connections 424 and 425, and conductors in dies 405 and 406, respectively.

The supply currents for the power supply voltages and/or ground voltages are delivered from the inductors and/or voltage regulator circuits 351 and 352 to one or more of IC dies 111-114, 311-314, and other IC dies in the stacks through conductors (e.g., conductive vias) in dies 405 and/or 406, through conductive connections 131 and/or 138, through conductors in connection device 103, and through conductive connections 132-137 and 331-336. Alternatively, or in addition, the supply currents for the power supply voltages and/or ground voltages can be delivered from the inductors and/or voltage regulator circuits 351 and 352 to one or more of the IC dies 311-318 and other IC dies in bottom and/or middle layers of the stacks through conductors (e.g., conductive vias) in dies 405 and/or 406, through conductive connections 424 and/or 425, through conductors in connection device 404, and through conductive connections 331-342. The power supply voltages and/or ground voltages from the inductors and/or voltage regulator circuits 351 and 352 are used to power circuits in one or more of IC dies 111-114, 311-318, and other IC dies in the stacks.

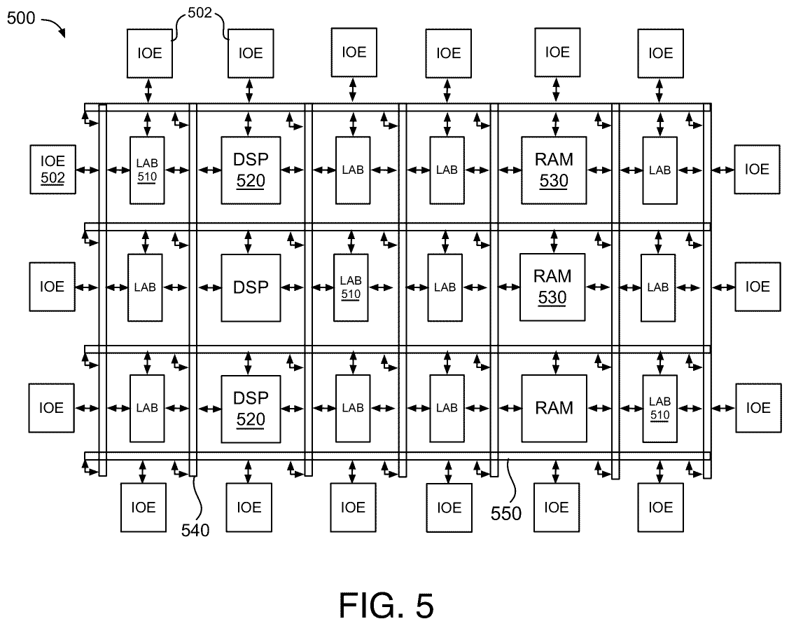

FIG. 5 is a diagram that illustrates an example of a configurable logic IC 500 that can be used with techniques disclosed herein. One, some, or all of the IC dies 111-116 and 311-318 disclosed herein with respect to FIGS. 1-4 can include the architecture of configurable logic IC 500 according to some examples. As shown in FIG. 5, the configurable logic integrated circuit (IC) 500 includes a two-dimensional array of configurable functional circuit blocks, including configurable logic array blocks (LABs) 510 and other functional circuit blocks, such as random access memory (RAM) blocks 530 and digital signal processing (DSP) blocks 520. Functional blocks such as LABs 510 can include smaller programmable logic circuits (e.g., logic elements, logic blocks, or adaptive logic modules) that receive input signals and perform custom functions on the input signals to produce output signals.

In addition, configurable logic IC 500 can have input/output elements (IOEs) 502 for driving signals off of configurable logic IC 500 and for receiving signals from other devices. Input/output elements 502 can include parallel input/output circuitry, serial data transceiver circuitry, differential receiver and transmitter circuitry, or other circuitry used to connect one integrated circuit to another integrated circuit. As shown, input/output elements 502 can be located around the periphery of the chip. If desired, the configurable logic IC 500 can have input/output elements 502 arranged in different ways. For example, input/output elements 502 can form one or more columns, rows, or islands of input/output elements that may be located anywhere on the configurable logic IC 500.

The configurable logic IC 500 can also include programmable interconnect circuitry in the form of vertical routing channels 540 (i.e., interconnects formed along a vertical axis of configurable logic IC 500) and horizontal routing channels 550 (i.e., interconnects formed along a horizontal axis of configurable logic IC 500), each routing channel including at least one conductor to route at least one signal.

Note that other routing topologies, besides the topology of the interconnect circuitry depicted in FIG. 5, may be used. For example, the routing topology can include wires that travel diagonally or that travel horizontally and vertically along different parts of their extent as well as wires that are perpendicular to the device plane in the case of three dimensional integrated circuits. The driver of a wire can be located at a different point than one end of a wire.

Furthermore, it should be understood that embodiments disclosed herein can be implemented in any integrated circuit or electronic system. If desired, the functional blocks of such an integrated circuit can be arranged in more levels or layers in which multiple functional blocks are interconnected to form still larger blocks. Other device arrangements can use functional blocks that are not arranged in rows and columns.

Configurable logic IC 500 can contain programmable memory elements. Memory elements can be loaded with configuration data using input/output elements (IOEs) 502. Once loaded, the memory elements each provide a corresponding static control signal that controls the operation of an associated configurable functional block (e.g., LABs 510, DSP blocks 520, RAM blocks 530, or input/output elements 502).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that can be controlled in this way include multiplexers (e.g., multiplexers used for forming routing paths in interconnect circuits), look-up tables, logic arrays, AND, OR, XOR, NAND, and NOR logic gates, pass gates, etc.

The programmable memory elements can be organized in a configuration memory array having rows and columns. A data register that spans across all columns and an address register that spans across all rows can receive configuration data. The configuration data can be shifted onto the data register. When the appropriate address register is asserted, the data register writes the configuration data to the configuration memory bits of the row that was designated by the address register.

In certain embodiments, configurable logic IC 500 can include configuration memory that is organized in sectors, whereby a sector can include the configuration RAM bits that specify the functions and/or interconnections of the subcomponents and wires in or crossing that sector. Each sector can include separate data and address registers.

The configurable logic IC of FIG. 5 is merely one example of an IC that can be used with embodiments disclosed herein. The embodiments disclosed herein can be used with any suitable integrated circuit or system. For example, the embodiments disclosed herein can be used with numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

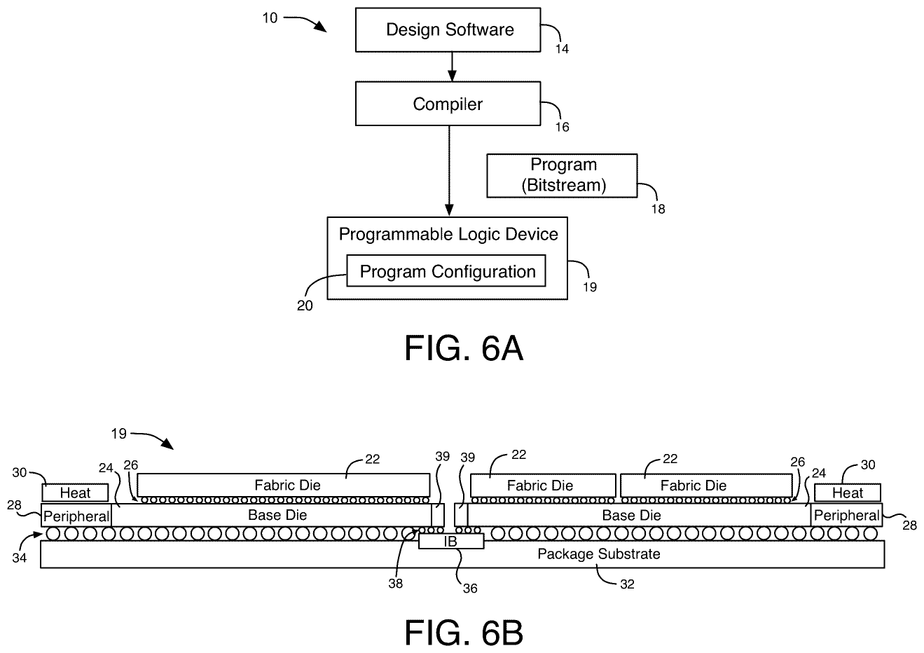

FIG. 6A illustrates a block diagram of a system 10 that can be used to implement a circuit design to be programmed into a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized task.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 6B, but many others can be used, and it should be understood that this disclosure is intended to encompass any suitable programmable logic device where programmable logic fabric and fabric support circuitry are at least partially separated on different integrated circuit die.

FIG. 6B is a diagram that depicts an example of the programmable logic device 19 that includes three fabric die 22 and two base die 24 that are connected to one another via microbumps 26. In the example of FIG. 6B, at least some of the programmable logic fabric of the programmable logic device 19 is in the three fabric die 22, and at least some of the fabric support circuitry that operates the programmable logic fabric is in the two base die 24. For example, some of the circuitry of configurable IC 500 shown in FIG. 5 (e.g., LABs 510, DSP 520, and RAM 530) can be located in the fabric die 22 and some of the circuitry of IC 500 (e.g., input/output elements 502) can be located in the base die 24.

Although the fabric die 22 and base die 24 appear in a one-to-one relationship or a two-to-one relationship in FIG. 6B, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 19. The heat spreaders 30 can appear above, as pictured, and/or below the package (e.g., as a double-sided heat sink). The base die 24 can attach to a package substrate 32 via conductive bumps 34. In the example of FIG. 6B, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 19 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

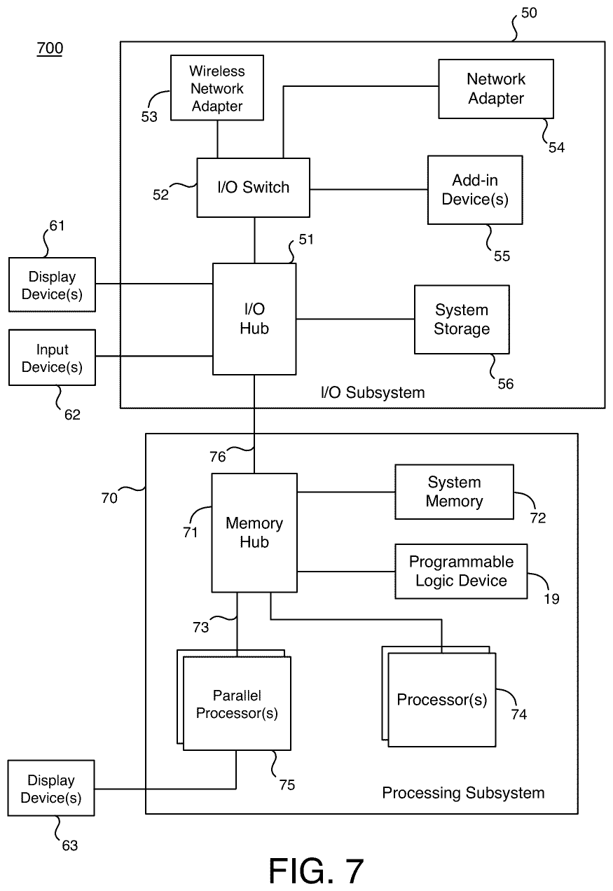

FIG. 7 is a block diagram illustrating a computing system 700 configured to implement one or more aspects of the embodiments described herein. The computing system 700 includes a processing subsystem 70 having one or more processor(s) 74, a system memory 72, and a programmable logic device 19 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 700 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 700. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 700 can include other components not shown in FIG. 7, including other port connections, optical storage drives, video capture devices, and the like, that can also be connected to the I/O hub 51. Communication paths interconnecting the various components in FIG. 7 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 700 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 700 can be integrated into a single package to form a system in package (SIP) configuration. In one embodiment, at least a portion of the components of the computing system 700 can be integrated into a multi-chip module (MCM), which can be interconnected with other multi-chip modules into a modular computing system.

The computing system 700 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 700. For example, any number of add-in cards or peripherals can be supported, or some components can be eliminated. Furthermore, some architectures can use different terminology for components similar to those illustrated in FIG. 7. For example, the memory hub 71 can be referred to as a Northbridge in some architectures, while the I/O hub 51 can be referred to as a Southbridge.

Additional examples are now described. Example 1 is an integrated circuit package comprising: first and second integrated circuit dies stacked vertically and coupled together; a first connection device coupled to the first integrated circuit die; and a power delivery device coupled to the first connection device, wherein the power delivery device comprises a first inductor that is coupled to provide supply current from the first inductor through the first connection device to the first integrated circuit die.

In Example 2, the integrated circuit package of Example 1 can optionally include, wherein the first connection device comprises a voltage regulator circuit that generates a power supply voltage, and wherein the power supply voltage is delivered from the voltage regulator circuit to the first inductor for generating the supply current.

In Example 3, the integrated circuit package of any one of Examples 1-2 further comprises: a second connection device coupled to the second integrated circuit die, wherein the second connection device comprises a voltage regulator circuit that generates a power supply voltage, and wherein the power supply voltage is delivered through the first connection device to the first inductor for generating the supply current.

In Example 4, the integrated circuit package of Example 3 further comprises: a third die coupled between the first and the second connection devices; and a substrate coupled to the third die and the second connection device, wherein the power supply voltage is delivered from the voltage regulator circuit to the first inductor through the substrate, through the third die, and through the first connection device for generating the supply current.

In Example 5, the integrated circuit package of any one of Examples 1˜4 can optionally include, wherein the first connection device is an interposer.

In Example 6, the integrated circuit package of any one of Examples 1-5 further comprises: a third integrated circuit die; and a fourth integrated circuit die stacked on top of the third integrated circuit die, wherein the first inductor is coupled to provide the supply current from the first inductor to the fourth integrated circuit die through the first connection device.

In Example 7, the integrated circuit package of any one of Examples 1-6 can optionally include, wherein the power delivery device further comprises a second inductor coupled to provide additional supply current from the second inductor to the first integrated circuit die through the first connection device.

In Example 8, the integrated circuit package of any one of Examples 1-7 further comprises: a third die coupled to the first connection device; and a substrate coupled to the third die, wherein an input voltage is delivered through the substrate, through the third die, and through the first connection device to the first inductor for generating the supply current.

In Example 9, the integrated circuit package of any one of Examples 1-8 further comprises: a third integrated circuit die coupled to the first connection device and positioned next to the first integrated circuit die, wherein the first inductor is coupled to provide the supply current from the first inductor to the third integrated circuit die through the first connection device.

In Example 10, the integrated circuit package of any one of Examples 1-9 can optionally include, wherein the first inductor generates the supply current for a power supply voltage.

Example 11 is a method for delivering supply current from a first inductor to a first integrated circuit die, the method comprising: providing an input voltage through a first connection device to the first inductor in a power delivery device, wherein the power delivery device, the first connection device, and the first integrated circuit die are in a package, wherein the first connection device is coupled between the power delivery device and the first integrated circuit die, and wherein the first integrated circuit die is vertically stacked on a second integrated circuit die; generating supply current through the first inductor; and transmitting the supply current from the first inductor through the first connection device to the first integrated circuit die.

In Example 12, the method of Example 11 further comprises generating the input voltage as a power supply voltage using a voltage regulator circuit in the first connection device.

In Example 13, the method of any one of Examples 11-12 further comprises: generating the input voltage as a power supply voltage using a voltage regulator circuit in a second connection device in the package, wherein the second connection device is coupled to the second integrated circuit die.

In Example 14, the method of Example 13 can optionally include, wherein providing the input voltage through the first connection device to the first inductor further comprises providing the input voltage from the voltage regulator circuit through the second connection device, through a substrate in the package, and through a third die coupled between the first and the second connection devices.

In Example 15, the method of any one of Examples 11-14 further comprises: transmitting additional supply current from a second inductor in the power delivery device through the first connection device to a third integrated circuit die in the package.

Example 16 is a circuit system comprising: first and second integrated circuit dies stacked vertically in the circuit system; a first connection device coupled to the first integrated circuit die; a second connection device coupled to the second integrated circuit die; and a power delivery device coupled to the first connection device, wherein the power delivery device comprises an inductor that generates supply current for a power supply voltage, wherein the supply current is delivered from the inductor to the first integrated circuit die through the first connection device.

In Example 17, the circuit system of Example 16 further comprises: third and fourth integrated circuit dies stacked vertically in the circuit system, wherein the supply current is delivered from the inductor to the third integrated circuit die through the first connection device.

In Example 18, the circuit system of any one of Examples 16-17 can optionally include, wherein the first connection device comprises a voltage regulator circuit that generates the power supply voltage.

In Example 19, the circuit system of any one of Examples 16-18 can optionally include, wherein the second connection device comprises a voltage regulator circuit that generates the power supply voltage, and wherein the power supply voltage is provided from the second connection device through the first connection device to the power delivery device.

In Example 20, the circuit system of any one of Examples 16-19 further comprises: a third die coupled between the first and the second connection devices, wherein the power supply voltage is delivered to the inductor through the third die.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. An integrated circuit package comprising:
first and second integrated circuit dies stacked vertically and coupled together;
a first connection device coupled to the first integrated circuit die; and
a power delivery device coupled to the first connection device, wherein the power delivery device comprises a first inductor that is coupled to provide supply current from the first inductor through the first connection device to the first integrated circuit die.

2. The integrated circuit package of claim 1, wherein the first connection device comprises a voltage regulator circuit that generates a power supply voltage, and wherein the power supply voltage is delivered from the voltage regulator circuit to the first inductor for generating the supply current.

3. The integrated circuit package of claim 1 further comprising:
a second connection device coupled to the second integrated circuit die, wherein the second connection device comprises a voltage regulator circuit that generates a power supply voltage, and wherein the power supply voltage is delivered through the first connection device to the first inductor for generating the supply current.

4. The integrated circuit package of claim 3 further comprising:
a third die coupled between the first and the second connection devices; and
a substrate coupled to the third die and the second connection device, wherein the power supply voltage is delivered from the voltage regulator circuit to the first inductor through the substrate, through the third die, and through the first connection device for generating the supply current.

5. The integrated circuit package of claim 1, wherein the first connection device is an interposer.

6. The integrated circuit package of claim 1 further comprising:
a third integrated circuit die; and
a fourth integrated circuit die stacked on top of the third integrated circuit die, wherein the first inductor is coupled to provide the supply current from the first inductor to the fourth integrated circuit die through the first connection device.

7. The integrated circuit package of claim 1, wherein the power delivery device further comprises a second inductor coupled to provide additional supply current from the second inductor to the first integrated circuit die through the first connection device.

8. The integrated circuit package of claim 1 further comprising:
a third die coupled to the first connection device; and
a substrate coupled to the third die, wherein an input voltage is delivered through the substrate, through the third die, and through the first connection device to the first inductor for generating the supply current.

9. The integrated circuit package of claim 1 further comprising:
a third integrated circuit die coupled to the first connection device and positioned next to the first integrated circuit die, wherein the first inductor is coupled to provide the supply current from the first inductor to the third integrated circuit die through the first connection device.

10. The integrated circuit package of claim 1, wherein the first inductor generates the supply current for a power supply voltage.

11. A method for delivering supply current from a first inductor to a first integrated circuit die, the method comprising:
providing an input voltage through a first connection device to the first inductor in a power delivery device, wherein the power delivery device, the first connection device, and the first integrated circuit die are in a package, wherein the first connection device is coupled between the power delivery device and the first integrated circuit die, and wherein the first integrated circuit die is vertically stacked on a second integrated circuit die;
generating supply current through the first inductor; and
transmitting the supply current from the first inductor through the first connection device to the first integrated circuit die.

12. The method of claim 11 further comprising:
generating the input voltage as a power supply voltage using a voltage regulator circuit in the first connection device.

13. The method of claim 11 further comprising:
generating the input voltage as a power supply voltage using a voltage regulator circuit in a second connection device in the package, wherein the second connection device is coupled to the second integrated circuit die.

14. The method of claim 13, wherein providing the input voltage through the first connection device to the first inductor further comprises providing the input voltage from the voltage regulator circuit through the second connection device, through a substrate in the package, and through a third die coupled between the first and the second connection devices.

15. The method of claim 11 further comprising:
transmitting additional supply current from a second inductor in the power delivery device through the first connection device to a third integrated circuit die in the package.

16. A circuit system comprising:
first and second integrated circuit dies stacked vertically in the circuit system;
a first connection device coupled to the first integrated circuit die;
a second connection device coupled to the second integrated circuit die; and
a power delivery device coupled to the first connection device, wherein the power delivery device comprises an inductor that generates supply current for a power supply voltage, wherein the supply current is delivered from the inductor to the first integrated circuit die through the first connection device.

17. The circuit system of claim 16 further comprising:
third and fourth integrated circuit dies stacked vertically in the circuit system, wherein the supply current is delivered from the inductor to the third integrated circuit die through the first connection device.

18. The circuit system of claim 16, wherein the first connection device comprises a voltage regulator circuit that generates the power supply voltage.

19. The circuit system of claim 16, wherein the second connection device comprises a voltage regulator circuit that generates the power supply voltage, and wherein the power supply voltage is provided from the second connection device through the first connection device to the power delivery device.

20. The circuit system of claim 16 further comprising:
a third die coupled between the first and the second connection devices, wherein the power supply voltage is delivered to the inductor through the third die.
